(19) United States
(12) Patent Application Publication
(10) Pub. No.: US 2011/0107061 A1
(43) Pub. Date: May 5, 2011

(54) Performance of first and second macros while data is moving through hardware pipeline

(76) Inventor: David A. Warren, El Dorado Hills, CA (US)

(21) Appl. No.: 12/610,208

(22) Filed: Oct. 30, 2009

(51) Int. Cl. G06F 15/76; G06F 9/02; G06F 9/30

(52) U.S. Cl. 712/28; 712/220; 712/E09.002; 712/E09.016

(57) ABSTRACT

A hardware pipeline has a number of rows including a first row, a last row, and an intermediate row between the first row and the last row. Each row stores a number of bytes of data as the data moves through the pipeline on a row-by-row basis from the first row towards the last row. A mechanism performs a first macro on the data beginning at the first row. The mechanism performs a second macro different than the first macro on the data beginning at the intermediate row where the first macro has been completely performed when the data has reached the intermediate row. The first and second macros each include a number of modifications of the data as the data moves through the pipeline to effect a complete transformation of the data. The complete transformation of the first macro is different than the complete transformation of the second data.

### BACKGROUND

Networking devices like switches are used to connect computing devices together to form networks. For example, a private network encompassing a number of computing devices may be communicatively connected to a public network like the Internet through a switch or a router. The switch or a router may perform various functionalities in this respect. The switch or router may, for instance, translate the external networking address of the private network as a whole into the internal networking addresses of the computing devices of the private network. In this way, a data packet received from the public network by the switch or router at the private network can be routed to the appropriate computing device within the private network.

### BRIEF DESCRIPTION OF THE DRAWINGS

FIG. 1 is a diagram of a device having a hardware pipeline in which two macros can be performed on data while the data is moving through the hardware pipeline, according to an embodiment of the present disclosure.

FIG. 2 is a diagram of the device of FIG. 1 in more detail, according to an embodiment of the present disclosure that is consistent with the embodiment of FIG. 1.

FIG. 3 is a flowchart of a method for performing two macros on data while the data is moving through a hardware pipeline, according to an embodiment of the present disclosure.

FIG. 4 is a diagram of a representative system in which the hardware pipeline of FIGS. 1 and/or 2 can be employed and in relation to which the method of FIG. 3 can be performed, according to an embodiment of the present disclosure.

### DETAILED DESCRIPTION

As noted in the background section, a networking device can communicatively connect the computing devices of a private network to a public network like the Internet. The private network may have an external networking address on the public network that identifies all the computing devices of the private network as a whole on the public network. However, within the private network, each computing device has its own private networking address that identifies the computing device individually on the private network. Therefore, when the networking device receives a data packet over the public network, the networking device translates the external networking address within the data packet to the private networking address of the computing device on the private network for which the data packet is intended. Other functionality can also be performed by the networking device, such as inserting or deleting tunnel headers, mirroring packets, and inserting, deleting and/or modifying virtual local-area network (VLAN) tags.

To perform such networking address translation and other functionality, the networking device may employ a hardware pipeline. Data enters the hardware pipeline at a first row of the pipeline, and is modified as the data moves through the pipeline until the data exits the pipeline at a last row of the pipeline. Existing implementations of effecting such transformations within hardware pipelines typically perform a single transformation of data within a single traversal of the data through a hardware pipeline. Therefore, if more than one transformation has to be performed on the data, the data has to reenter the hardware pipeline one or more additional times, which slows processing performance of the data.

The inventor has developed an approach that overcomes this shortcoming. In particular, two or more transformations can be sequentially effected within a hardware pipeline as data moves through the hardware pipeline. Once a first transformation has been completed on the data by the time the data has reached an intermediate row of the hardware pipeline after having entered the pipeline at the first row, a second transformation can then be performed on the data as the data moves through the pipeline from the intermediate row to the last row. Therefore, the data does not have to reenter the hardware pipeline for the second transformation to be performed, which increases processing performance of the data.

It is noted that while at least some embodiment of the present disclosure are described herein in relation to a networking device that processes data packets, the present disclosure can more generally be implemented in relation to any type of device that employs a hardware pipeline for modifying data as the data moves through the pipeline. For example, embodiments of the present disclosure can be applied to hardware pipelines in devices as diverse as audio and/or video processing devices, real-time medical imaging devices, and telemetry devices, among other types of devices.

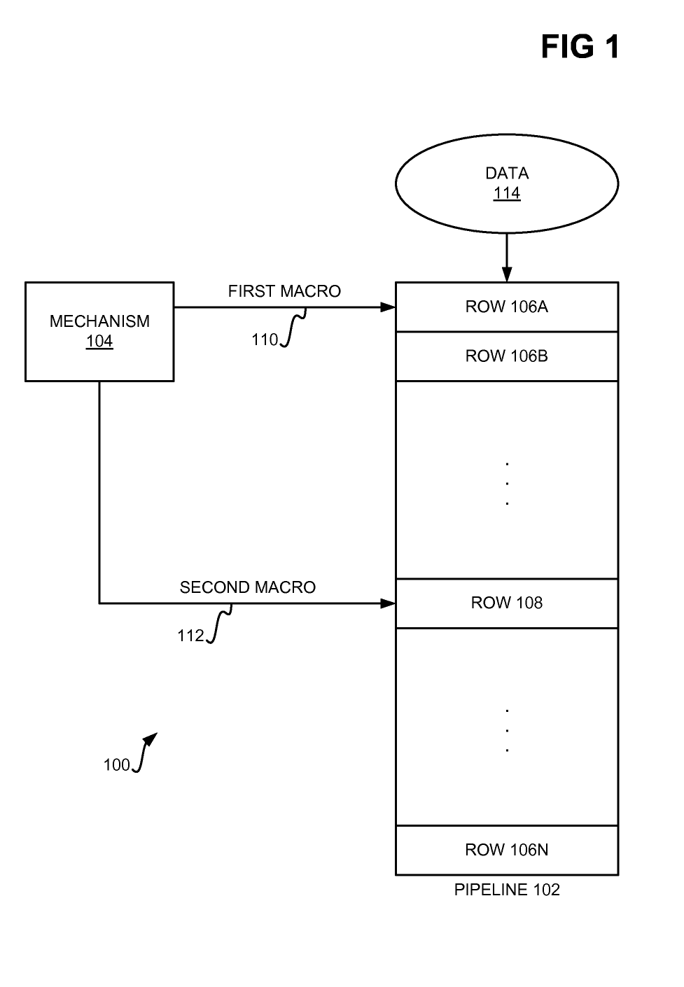

FIG. 1 shows a device 100, according to an embodiment of the disclosure. The device 100 includes a hardware pipeline 102. The pipeline 102 is a hardware pipeline in that it is implemented in hardware, such as various semiconductor circuits like application specific integrated circuits (ASIC's). The pipeline 102 includes a number of rows 106A, 1068, . . . , 106N, collectively referred to as the rows 106. Each row 106 stores a (typically identical) number of bytes of data.

A particular intermediate row 108 of the hardware pipeline 102 is explicitly called out in FIG. 1. In one embodiment, the intermediate row 108 is predetermined prior to any data 114 entering the hardware pipeline 102, and is thereafter fixed and static in that which row 106 is considered to be the intermediate row 108 does not change after the intermediate row 108 has been selected. In another embodiment, the intermediate row 108 is dynamic, however, in that which row 106 is considered to be the intermediate row 108 can change once the data 114 has entered the hardware pipeline 102. In this embodiment, the intermediate row 108 may not be predetermined prior to any data 114 entering the hardware pipeline 102.

The data 114 enters the hardware pipeline 102 at the first row 106A, and proceeds through the pipeline 102 on a row-by-row basis towards the last row 106N, typically moving from one row to another on every edge of a clock signal. The data 114 may include Y bytes, where each row 106 stores X bytes, where X is typically less than Y. For example, in the case where Y is equal to or greater than two times X, the movement process of the data 114 through the hardware pipeline 102 is as follows. The first X bytes of the data 114 enters the hardware pipeline 102 at the first row 106A. Next, the first X bytes of the data 114 is moved to the second row 106B, while the second X bytes of the data 114 enters the hardware pipeline 102. This movement process continues until the last bytes of the data 114 enters and then exits the hardware pipeline 102, such as at the last row 106N.

It is noted that the data 114 may be a complete data packet, such as a data packet that is received over a network by the device 100 where the device 100 is a networking device like a switch or a router. In such instance, the Y bytes of the data 114 may not be an even multiple of the X bytes stored in each row 106 of the hardware pipeline 102. Rather, Y may equal to a multiple A of X plus a remainder B less than X, such that Y=AX+B. In this case, after the first AX bytes of the data 114 have entered the hardware pipeline 102, the remaining B bytes of the data 114 that enter the pipeline 102 do not completely fill the X bytes of the first row 106A. Therefore, the first X minus B bytes of the next data packet may fill the X bytes of the first row 106A that are not filled by the last B bytes of the data 114.

The device 100 also includes a mechanism 104. The mechanism 104 may be implemented in hardware, software, or a combination of hardware and software. The mechanism 104 performs a first macro 110 on the data 114 when the data 114 enters the first row 106A of the hardware pipeline 106A, and may perform a second macro 112 on the data 114 when the data 114 moves to the intermediate row 108. Each of the macros 110 and 112 is defined as corresponding to a complete transformation of the data 114, where the complete transformation of the first macro 110 is different than the complete transformation of the second macro 112. In this respect, each of the macros 110 and 112 encompasses or includes a number of modifications that are made to the data 114 as the data 114 moves through the hardware pipeline 102, in order to effect the complete transformation in question.

For example, one complete transformation in the case where the device 100 is a networking device like a switch or a router may be the translation of a networking address of a data packet from an external networking address to an internal networking address. This transformation includes all the modifications that have to be made to the data 114, as the data 114 moves through the hardware pipeline 102, to change the networking address from the external networking address to the internal networking address. Other types of transformations that can be performed in the context of a network device include inserting or deleting tunnel headers for tunnel ingress and egress, respectively, recalculation of checksums, inserting, deleting, and/or modifying VLAN and/or multiprotocol label switching (MPLS) tags, manipulating Internet Protocol security (IPSEC) headers, among other types of transformations.

A complete transformation of the data 114 cannot be arbitrarily divided into a first partial transformation of the data 114 and a second partial transformation of the data 114 such that each of the macros 110 and 112 corresponds to just a partial transformation of the data 114. Each of the macros 110 and 112 corresponds to a complete transformation of the data 114, which is the transformation of the data 114 to achieve a desired goal, such as networking address translation, and so on. The attempted division of the modifications that a given macro performs into more than one macro is thus improper, because each such hypothetical resulting macro would not individually and separately correspond to a different complete transformation. The macros 110 and 112 are thus separate from one another.

When the data 114 enters the first row 106A of the hardware pipeline 102, the mechanism 104 begins performing the first macro 110 on the data 114 beginning at the first row 106A. The mechanism 104 performs the first macro 110 as the data 114 moves through the hardware pipeline 102 from the first row 106A towards the last row 106N of the pipeline 102. In each such row 106, the mechanism 104 modifies the data 114 as stored in the rows 106 in question, such that the sum total of all the modifications effects the complete transformation of the first macro 110.

When the data 114 reaches the intermediate row 108, one of two situations will have occurred. First, the mechanism 104 may not yet have completed performing the first macro 110 on the data 114. In this situation, the mechanism 104 continues performing the first macro 110 on the data 114 as the data 114 moves through the hardware pipeline 102 from the intermediate row 108 towards the last row 106N of the pipeline 102. The pipeline 102 has a sufficient number of rows 106 so that for any given macro, the macro will be completely performed by the time the data 114 reaches the last row 106N. Therefore, in this situation, the data 114 exits the hardware pipeline 102 at the law row 106N, with just the first macro 110 having been performed on the data 114. The data 114 will have to reenter the hardware pipeline 102 if there is a second macro 112 to be performed on the data 114, and the second macro 112 will be performed on the data 114 beginning at the row 106A.

However, second, the mechanism 104 may have completed performing the first macro 110 on the data 114 when the data 114 reaches the intermediate row 108. If there is a second macro 112 to be performed on the data 114, then the second macro 112 is performed on the data 114 beginning at the intermediate row 108, and continuing as the data 114 moves through the hardware pipeline 102 from the intermediate row 108 towards the last row 106N of the pipeline 102. In each such row 106, the mechanism 104 modifies the data 114 as stored in the rows 106 in question, such that the sum total of all the modifications effects the complete transformation of the second macro 112. Therefore, the data 114 exits the pipeline 102 at the last row 106N, with both the first macro 110 and the second macro 112 having been performed on the data 114. The data 114 does not have to enter the hardware pipeline 102 a second time for the second macro 112 to be performed on the data 114, after the data has already entered the pipeline 102 a first time.

The first and the second macros 110 and 112 may be selected by the mechanism 104 (from a number of such macros) a priori so that both the first and the second macros 110 and 112 can be performed on the data 114 during a single traversal of the data 114 through the hardware pipeline 102. In particular, the second macro 112 is selected so that if the mechanism 104 begins performing the second macro 112 on the data 114 at the intermediate row 108, the second macro 112 will be completely performed by the time the data 114 reaches the last row 106N of the hardware pipeline 102. Alternatively, if the first macro 110 has been completely performed on the data 114 by the time the data 114 reaches the intermediate row 108, the mechanism 104 can determine whether there is a suitable second macro 112 to perform on the data 114 beginning at the intermediate row 108 that will be completely performed by the time the data 114 reaches the last row 106N. The mechanism 104 is thus advantageously reused to perform the second macro 112 in addition to the first macro 110, in lieu of having two separate mechanisms.

There may not be a second macro 112 that can be performed on the data 114 beginning at the intermediate row 108 such that the second macro 112 is completely performed by the time the data 114 reaches the last row 106N. In this case, if the mechanism 104 has finished performing the first macro 110 on the data 114 by the time the data 114 reaches the intermediate row 108, the data 114 will exit the hardware pipeline 102 at the intermediate row 108, instead of having to move through the remainder of the pipeline 102 and exit the pipeline 102 at the last row 106N. This is advantageous, because any subsequent processing that is to be performed on the data 114 after the data exits the hardware pipeline 102 can begin sooner, when the data 114 exits the pipeline 102 early at the intermediate row 108, instead of having to wait for the data 114 to move through the remainder of the pipeline 102 and exit at the last row 106N.

While both the macros 110 and 112 can be performed on the data 114 during a single traversal of the data 114 through the hardware pipeline 102, the macros 110 and 112 are nevertheless separate from one another. That is, the macros 110 and 112 do not have to be combined into a single and more complex macro for their complete transformations of the data 114 to be achieved during a single traversal of the data 114. The macro 110 may not be aware, for instance, that the macro 112 will subsequently be performed on the data 114 during the same traversal of the data 114 through the hardware pipeline 102, and the macro 112 may not be aware that the macro 110 has already been performed on the data 114 during this same traversal of the data 114 through the pipeline 102.

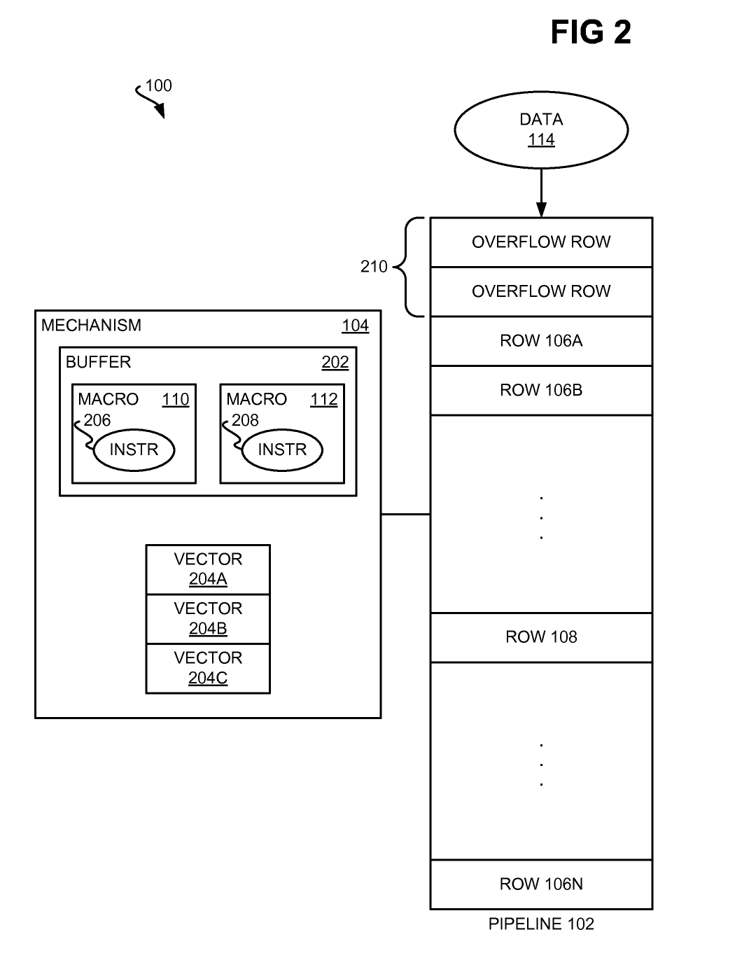

FIG. 2 shows the device 100 in more detail, according to an embodiment of the disclosure that is consistent with the embodiment of FIG. 1. The mechanism 104, which may be referred to as a transformation engine, includes a macro buffer 202, as well as a number of vectors 204A, 204B, and 204C, collectively referred to as the vectors 204. Prior to processing the data 114 within the hardware pipeline 102, the macros 110 and 112 are moved into the macro buffer 202.

The macro 110 includes a number of instructions 206, whereas the macro 112 includes a number of instructions 208. Execution of the instructions 206 and 208 on the data 114 moving through the hardware pipeline 102 results in performance of the macros 110 and 112. The vectors 204 can store one instruction 206 or 208 at a given time. For example, each instruction 206 and 208 may have a total of R bits, and each vector 204 may be able to store a total of S bits, such that R=nS, where n is the number of vectors 204. In the example of FIG. 2, n=3, such that R=35.

As the data 114 moves down the rows 106 of the hardware pipeline 102 beginning at the first row 106A, different instructions 206 of the macro 110 are loaded into the vectors 204 and executed. Once the data 114 reaches the row 108 and continues moving down the rows 106 towards the last row 106N, different instructions 208 of the macro 112 are loaded into the vectors 204 and executed. In this way, the macros 110 and 112 are performed in relation to the data 114 as the data 114 moves through the pipeline 102, where the macro 110 is performed on the data 114 beginning at the row 106A, and the macro 112 is performed on the data beginning at the row 108.

A given instruction stored in the vectors 204 may have to operate simultaneously on a number of bytes of the data 114. However, the number of bytes that can be stored in a given row 106 may be less than the number of bytes that the instruction in question is to operate on. For example, an instruction may have to operate on Z bytes, but each row 106 may just store X bytes, where X<Z. This means that the instruction ordinarily would not be able to operate on the data 114 when the first bytes of the data 114 is moved into the first row 106A of the hardware pipeline 106, because just the first X bytes of the data 114 are initially loaded into the first row 106A. Rather, the instruction would have to wait until enough bytes of the data 114 equal to or greater than the number of bytes that the instruction has to operate on have been moved into the top rows 106 (including the first row 106A).

To avoid this delay, the hardware pipeline 102 includes one or more overflow rows 210 prior to the first row 106A in the embodiment of FIG. 2. The overflow rows 210 may each store the same number of bytes of data that each row 106 stores. The data 114 is loaded into the overflow rows 210 prior to being loaded into the rows 106 of the hardware pipeline 106. In the example of FIG. 2, there are two overflow rows 210. However there may be more or less of such overflow rows 210, depending on the maximum number of bytes any given instruction has to operate on in comparison to the number of bytes that each row 106 can store. In general, there is a sufficient number of overflow rows 210 so that each instruction can be performed on the data 114 beginning at the first row 106A and the overflow rows 210 of the hardware pipeline 102.

For example, a given instruction may have to operate on Z bytes of the data 114 that is greater than twice the number of X bytes that each row 106 and 210 of the hardware pipeline 102 can store, but less than three times the number of X bytes that each row 106 and 210 can store. For this instruction to be able to operate on the data 114 starting at the first row 106A when the first X bytes of the data 114 is loaded into the first row 106A, there are at least two overflow rows 210. The first row 106A stores the first X bytes of the data 114, the first overflow row 210 stores the second X bytes of the data 114, and the second overflow row 210 stores the third X bytes of the data 114. Because the instruction has to operate on Z bytes of the data 114 that is between twice the number of X bytes that each row 106 and 210 can store (i.e., 2X<z<3X), two overflow rows 210 are the minimum number of overflow rows 210 for the instruction to operate on the data 114 when the first X bytes of the data 114 are loaded into the first row 106A.

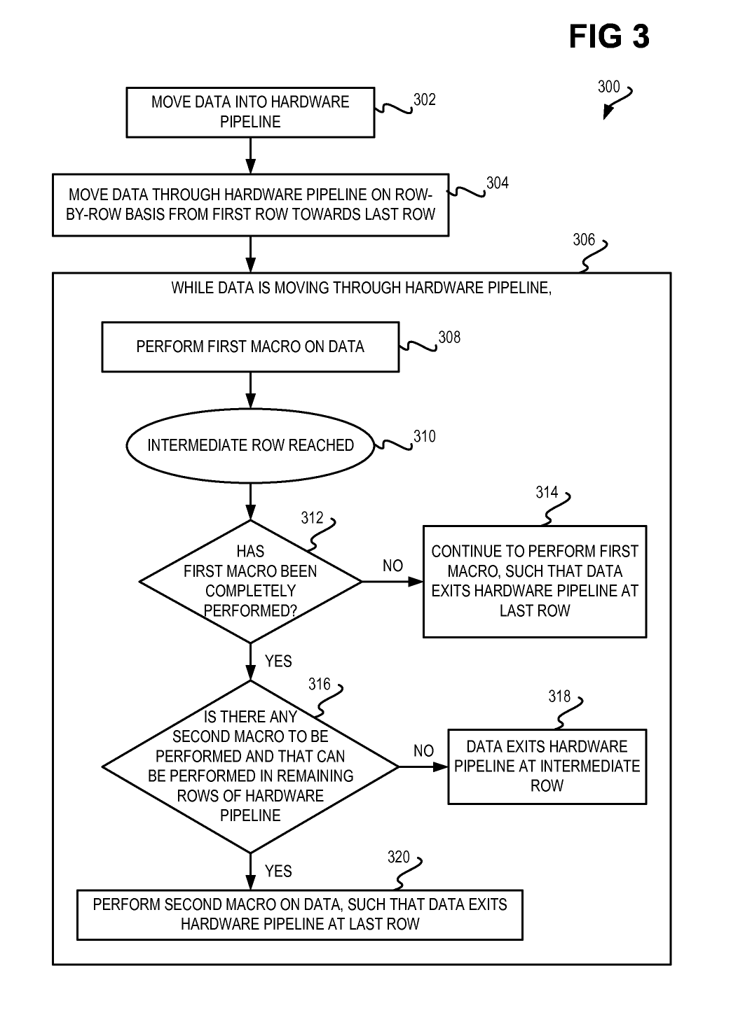

FIG. 3 shows a method 300 of the performance of the device 100, according to an embodiment of the disclosure. The data 114 is moved into the hardware pipeline 102 (302), specifically at the first row 106A of the pipeline 102. The data is then moved through the hardware pipeline 102 on a row-by-row basis, from the first row 106A and towards the last row 106N of the pipeline 102 (304).

While the data is moving through the hardware pipeline 102 in this manner, the following occurs (306). The first macro 110 is performed on the data 114 as the first macro 110 moves from the first row 106A towards the intermediate row 108 (308). At some point the data 114 reaches the intermediate row 108 while moving through the hardware pipeline 102 (310). If the first macro 110 has not been completely performed by the time the data 114 reaches the intermediate row 108 (312), then performance of the first macro 110 continues until completion, and the data 114 exits the hardware pipeline 102 at the last row 106N (314). That is, the first macro 110 continues to be performed from the intermediate row 108 towards the last row 106N, and the data 114 exits the hardware pipeline 102 at the last row 106N.

However, if the first macro 110 has been completely performed by the time the data 114 reaches the intermediate row 108 (312), but if there is no second macro 112 to perform on the data 114 (316), then the data 114 exits the hardware pipeline 102 early at the intermediate row 108 (318), instead of at the last row 106N. By comparison, if the first macro 110 has been completely performed by the time the data 114 reaches the intermediate row 108 (312), and there is a second macro 112 to perform on the data 114 (316), then the second macro 112 is performed on the data 114, and the data 114 exits the hardware pipeline 102 at the last row 106N (320). That is, the second macro 110 is performed from the intermediate row 108 towards the last row 106N, and the data 114 exits the hardware pipeline 102 at the last row 106N.

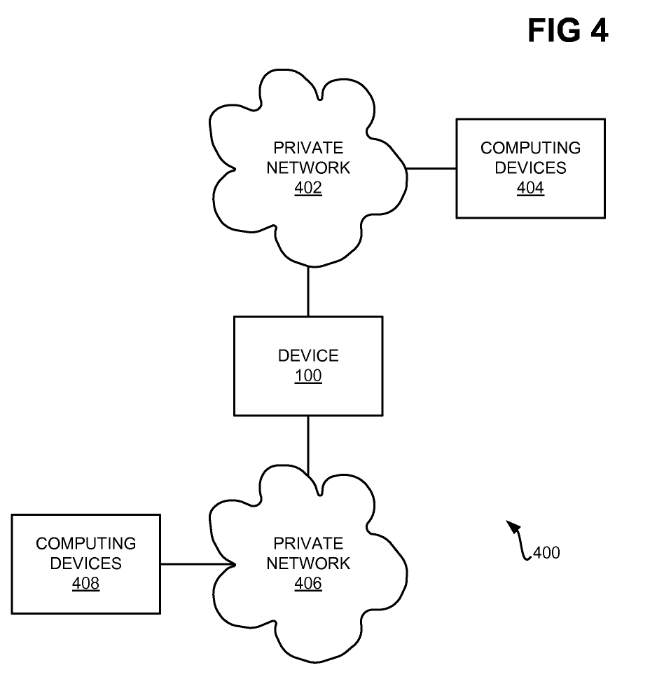

In conclusion, FIG. 4 shows a representative system 400 that can include the device 100 and in relation to which the method 300 can be performed, according to an embodiment of the disclosure. In the example of FIG. 4, the device 100 is a networking device, such as a router or a switch. The device 100 is communicatively connected to both a private network 402 and a public network 406, where the latter can be or include the Internet. The private network 402 includes a number of computing devices 404, whereas a number of different computing devices 408 are communicatively connected to the public network 406.

The device 100 receives data over the public network 406 from the computing devices 408 that is intended for one or more of the computing devices 404. The device 100 modifies the data using the hardware pipeline 102 as has been described, such as via the method 300, and then sends the data to the computing devices 404 in question over the private network 402. For instance, the device 100 may perform networking address translation, or other functions. The device 100 may also receive data over the private network 402 from the computing devices 404 that is intended for one or more of the computing devices 408. The device 100 may thus modify this data using the hardware pipeline 102 as has been described, such as via the method 300, before sending the data to the computing devices 408 in question over the public network 406.

We claim:

1. A device (100) comprising:
a hardware pipeline (102) having a plurality of rows including a first row, a last row, and an intermediate row between the first row and the last row, each row to store a number of bytes of data as the data moves through the hardware pipeline on a row-by-row basis from the first row towards the last row; and,
a mechanism (104) to perform a first macro on the data beginning at the first row, and a second macro different than the first macro on the data beginning at the intermediate row where the first macro has been completely performed when the data has reached the intermediate row,
wherein the first macro and the second macro each comprises a plurality of modifications of the data as the data moves through the hardware pipeline to effect a complete transformation of the data, the complete transformation of the first macro different than the complete transformation of the second data.

2. The device of claim 1, wherein the first macro and the second macro are separate from one another, so that the complete transformations of the first macro and the second macro are performed on the data in a single traversal of the pipeline without having to combine the first macro and the second macro into a single macro.

3. The device of claim 1, wherein the first macro and the second macro are performed on the data in a single traversal of the data through the hardware pipeline, such that the data does not have to enter the hardware pipeline a second time for the second macro to be performed on the data after the data has entered the hardware pipeline a first time for the first macro to be performed on the data.

4. The device of claim 1, wherein where there is no second macro, the data is to exit the hardware pipeline early at the intermediate row instead of having to move through the hardware pipeline completely to the last row.

5. The device of claim 1, wherein where the first macro has not been completely performed when the data has reached the intermediate row, the mechanism is to continue performing the first macro on the data as the data moves from the intermediate row to the last row on a row-by-row basis, such that the second macro is performed on the data in a subsequent traversal of the data through the hardware pipeline.

6. The device of claim 1, wherein the data is to exit the hardware pipeline at the last row where both the first macro and the second macro are performed on the data or where the first macro has not been completely performed when the data has reached the intermediate row,
and wherein the data is to exit the hardware pipeline at the intermediate row where the first macro has been completely performed when the data has reached the intermediate row and where there is no second row.

7. The device of claim 1, wherein the intermediate row is a predetermined row selected prior to the data entering the hardware pipeline.

8. The device of claim 1, wherein the mechanism is to select the first macro and the second macro from a plurality of macros to be performed on the data such that both the first macro and the second macro can be performed on the data in a single traversal of the data through the hardware pipeline.

9. The device of claim 1, wherein the mechanism comprises:
a macro buffer (202) to store the first macro and the second macro, each of the first and the second macro comprising a plurality of instructions;
one or more vectors (204), the vectors in total to store a given instruction of the instructions of the first macro and the second macro.

10. A method (300) comprising:
moving data into a hardware pipeline having a plurality of rows including a first row, a last row, and an intermediate row between the first row and the last row, each row to store a number of bytes of the data, the data moved into the hardware pipeline at the first row (302);
moving the data through the hardware pipeline on a row-by-row basis from the first row towards the last row;
while the data is moving through the hardware pipeline on the row-by-row basis from the first row towards the last row,
performing a first macro on the data; and,
where the first macro has been completely performed when the data has reached the intermediate row and where there is a second macro to perform on the data,
performing the second macro on the data, such that the data exits the hardware pipeline at the last row,
wherein the first macro and the second macro each comprises a plurality of modifications of the data as the data moves through the hardware pipeline to effect a complete transformation of the data, the complete transformation of the first macro different than the complete transformation of the second data.
